(19) United States
(12) Patent Application Publication
(10) Pub. No.: US 2026/0034953 A1
(43) Pub. Date: Feb. 5, 2026

(54) VEHICLE AND CONTROL METHOD THEREOF

(71) Applicants: Hyundai Motor Company, Seoul (KR); Kia Corporation, Seoul (KR)

(72) Inventors: Sang Kyung SEO, Hwaseong-Si (KR); Jae Hyun KIM, Hwaseong-Si (KR)

(21) Appl. No.: 19/203,668

(22) Filed: May 9, 2025

(30) Foreign Application Priority Data
Aug. 2, 2024 (KR) 10-2024-0103376

(51) Int. Cl. B60R 16/037; B60H 1/00; B60N 2/02; B62D 1/18

(52) U.S. Cl. CPC B60R 16/037; B60H 1/00742; B60N 2/0244; B62D 1/18

(57) ABSTRACT

A vehicle and a control method thereof are provided. A mode control device may include: a sensor to detect seating information of a vehicle and a user state sitting on the vehicle; memory storing information on at least one control mode related to the vehicle; and a processor connected to the memory. The processor may be configured to: determine, via communication with the sensor, the seating information of the vehicle and the user state; determine, based on at least one of the seating information or the user state, a control mode of a plurality of control modes for the vehicle; and, control, based on the control mode, at least one vehicle object in the vehicle

### CROSS-REFERENCE TO RELATED APPLICATION

This application claims priority to and the benefit of Korean Patent Application No. 10-2024-0103376, filed on Aug. 2, 2024, the disclosure of which is incorporated herein by reference in its entirety.

### FIELD

The present disclosure relates to vehicles and more specifically relates to controlling interior environments of vehicles.

### BACKGROUND

Various systems and functions in vehicles for the convenience of occupants are available in the market.

For car seats, for example, a massage function has been added. Ambient light inside the vehicle has diversified, and electric curtains that take privacy into consideration and the like have been adopted to the vehicle.

Configurations inside the vehicle having various color outputs and functions can stimulate the emotions of occupants and provide special experiences.

However, since the above convenience configurations are provided only uniformly according to a user's selection, customization options for each mode and user have tended to be limited.

### SUMMARY

The present disclosure was devised to solve the above technical problems and is directed to controlling various modes for providing convenience functions and moods of a vehicle by considering seating information of the vehicle and a user's state.

The technical problems to be solved by the present disclosure are not limited to the above-mentioned technical problems, and other problems which are not mentioned will be clearly understood by those skilled in the art from the following description.

According to one or more example embodiments of the present disclosure, a mode control device may include: a sensor to detect seating information of a vehicle and a user state sitting on the vehicle; memory storing information on at least one control mode related to the vehicle; and a processor connected to the memory. The processor may be configured to: determine, via communication with the sensor, the seating information of the vehicle and the user state; determine, based on at least one of the seating information or the user state, a control mode of a plurality of control modes for the vehicle; and control, based on the control mode, at least one vehicle object in the vehicle (e.g., during driving of the vehicle, during autonomous driving of the vehicle, etc.).

The at least one vehicle object may include at least one of: an interior light, a seat, an electric curtain, a steering wheel, an air conditioning system, or a scent diffuser. Each control mode, of the plurality of control modes, may correspond to a different setting for at least one of: the interior light, the seat, the electric curtain, the steering wheel, the air conditioning system, or the scent diffuser.

The processor may be configured to control the at least one vehicle object by individually controlling at least two vehicle objects in the vehicle according to the control mode.

Each of the at least two vehicle objects may be related to at least one seat on which at least one user is sitting.

The processor may be configured to control the at least two vehicle objects by: determining a support function of each of the at least two vehicle objects; and controlling the support function of each of the at least two vehicle objects. The processor may be configured to determine the control mode by:

determining, based on the seating information and the user state, at least one recommended control mode; outputting, via a user interface, the at least one recommended control mode; and determining the control mode by receiving, via the user interface, a selected control mode of the at least one recommended control mode.

The processor may be configured to display, via the user interface, the at least one recommended control mode by visually distinguishing the at least one recommended control mode among the plurality of control modes.

The processor may be configured to determine the at least one recommended control mode by: determining, as the at least one recommended control mode, at least one control mode that is selected by a number of a plurality of users. The number of the plurality of users may satisfy a threshold.

The processor may be configured to determine the at least one recommended control mode by: determining the at least one recommended control mode further based on a priority factor associated with the user state.

The processor may be configured to determine the at least one recommended control mode by: determining the at least one recommended control mode further based on an accumulatively learned content by an artificial intelligence model using the seating information and the user state.

Two or more control modes, of the plurality of control modes, may be classified as two different group modes having different power conditions.

According to one or more example embodiments of the present disclosure, a vehicle may include: a sensor to detect seating information of the vehicle and a user state sitting on the vehicle; a user interface configured to receive a user input associated with at least one control mode related to the vehicle; memory storing information on the at least one control mode related to the vehicle; and a processor connected to the memory. The processor may be configured to: determine, via communication with the sensor, the seating information of the vehicle and the user state; based on at least one of the seating information or the user state, determine a control mode of a plurality of control modes for the vehicle; and control, based on the control mode, at least one vehicle object in the vehicle.

According to one or more example embodiments of the present disclosure, a method performed by an apparatus of a vehicle may include: detecting, via a sensor of the vehicle, seating information of the vehicle and a user state sitting on the vehicle; determining, via communication with the sensor, the seating information of the vehicle and the user state; determining, based on at least one of the seating information or the user state, a control mode of a plurality of control modes for the vehicle; and controlling, based on the control mode, at least one vehicle object in the vehicle.

The at least one vehicle object may include at least one of: an interior light, a seat, an electric curtain, a steering wheel, an air conditioning system, or a scent diffuser. Each control mode, of the plurality of control modes, may correspond to a different setting for at least one of: the interior light, the seat, the electric curtain, the steering wheel, the air conditioning system, or the scent diffuser.

Controlling the at least one vehicle object may include individually controlling at least two vehicle objects in the vehicle according to the control mode.

Each of the at least two vehicle objects may be related to at least one seat on which at least one user is sitting.

Individually controlling the at least two vehicle objects may include: determining a support function of each of the at least two vehicle objects; and controlling the support function of each of the at least two vehicle objects.

Determining the control mode may include: determining, based on the seating information and the user state, at least one recommended control mode; outputting, via a user interface, the at least one recommended control mode; and determining the control mode by receiving, via the user interface, a selected control mode of the at least one recommended control mode.

Outputting the at least one recommended control mode may include: displaying, via the user interface, the at least one recommended control mode by visually distinguishing the at least one recommended control mode among the plurality of control modes.

Determining the at least one recommended control mode may include: determining, as the at least one recommended control mode, at least one control mode that is selected by a number of a plurality of users. The number of the plurality of users may satisfy a threshold.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a configuration diagram illustrating a mode control device of a vehicle;

FIG. 2 is a flowchart illustrating a process of operating a mode;

FIG. 3 is a flowchart illustrating a specific operation of operation S250 in FIG. 2;

FIGS. 4, 5, and 6 are exemplary diagrams of a screen which recommends control modes;

FIG. 7 is a flowchart illustrating a specific operation of operation S270 in

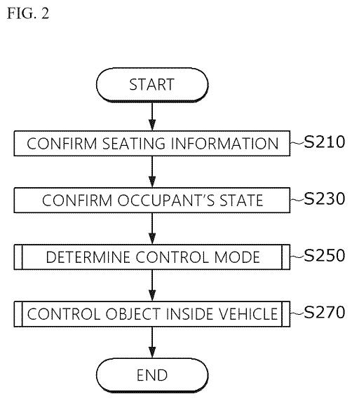

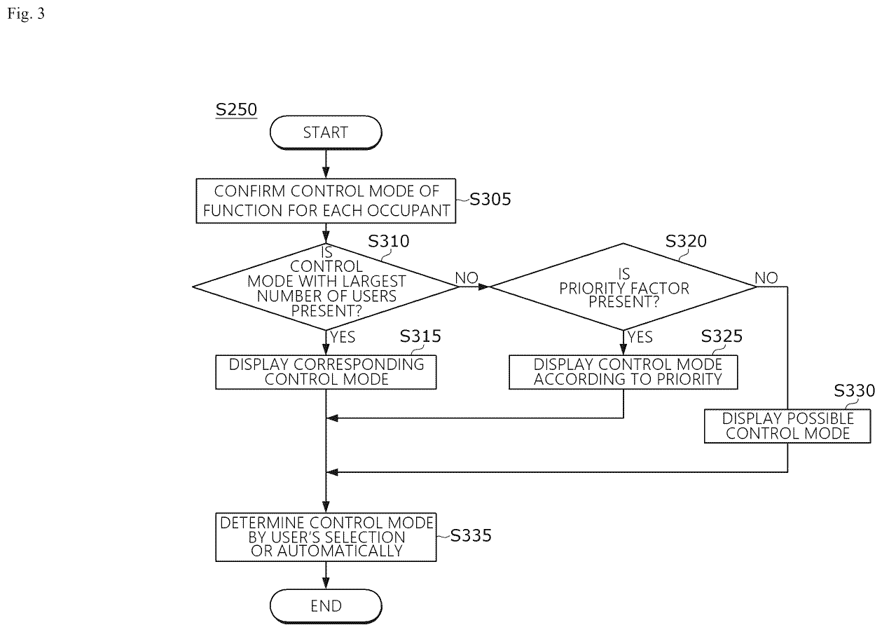

FIG. 2; and

FIG. 8 is an exemplary diagram illustrating the internal components of a vehicle to be controlled in the control mode.

### DETAILED DESCRIPTION

Hereinafter, one or more example embodiments of the present disclosure will be described in detail with reference to the accompanying drawings.

However, the technical spirit of the present disclosure is not limited to the example embodiments to be described, but may be implemented in various different forms, and one or more of the components between the example embodiments may be selectively combined or replaced within the technical idea of the present disclosure and used.

Further, the terms (including technical and scientific terms) used in the example embodiments of the present disclosure may be interpreted as meanings which may be generally understood by those skilled in the art unless specifically defined and described, and terms which are generally used such as terms defined in dictionaries may be interpreted by considering the contextual meanings in the related art.

In addition, the terms used in the example embodiments of the present disclosure are not intended to limit the present disclosure but to describe the example embodiments.

In the present specification, the singular form may include the plural form unless the context clearly indicates otherwise, and the expression “at least one (or one or more) of A, B, and C” may refer to one or more of all combinations of A, B, and C. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Further, terms such as first, second, A, B, (a), (b), and the like may be used in describing the components of the example embodiments of the present disclosure.

These terms are only provided to distinguish the components from other components, and the nature, sequence, order, or the like of the corresponding components are not limited by the terms.

Further, when a specific component is described as being “connected,” “coupled,” or “linked” to another component, the component may include not only a case of being directly connected, coupled, or linked to the other component but also a case of being “connected,” “coupled,” or “linked” to the other component with another component interposed between the component and the other component.

In addition, when one component is disclosed as being formed or disposed “on (above) or under (below)” another element, the expression “on (above) or under (below)” includes not only a case in which two components are in direct contact with each other, but also a case in which one or more other components are formed or disposed between the two components. In addition, when the expression “on (above) or under (below)” is expressed, it may mean not only an upward direction but also a downward direction based on one component.

The term “first row” mentioned in the present document may mean a region where a driver's seat and a passenger's seat are located, and the term “second row” may mean seats located behind the first row.

A “mood curator mode” mentioned in the present document may be interpreted as a mode in which objects to be controlled for the convenience of vehicle occupants and the mood of a vehicle and functions supported by the corresponding objects are grouped. The “mood curator mode” may also be referred to as a “control mode.” This mood curator mode may be composed of at least two or more modes.

In various flowcharts of the present document, at least some of the operations may be omitted or the order of each operation may be changed, and at least some of the various example embodiments of the present document may be additionally performed at a specific time point in each operation. The various flowcharts of the present document may be performed by at least one of the instructions included in a mode control device 100, a processor 130, or a memory.

An automation level of an autonomous driving vehicle may be classified as follows, according to the American Society of Automotive Engineers (SA E). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SA E classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., seating information and a user state) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., seating information and a user state) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., seating information and a user state) described herein. Minimum risk maneuver (MRM) operation(s) may also be controlled, for example, based on one or more features (e.g., seating information and a user state) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., seating information and a user state) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IM U sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., seating information and a user state) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Hereinafter, one or more example embodiments will be described in detail with reference to the accompanying drawings, and the same reference numerals may be given to the same or corresponding components regardless of the drawing numbers, and redundant descriptions thereof will be omitted.

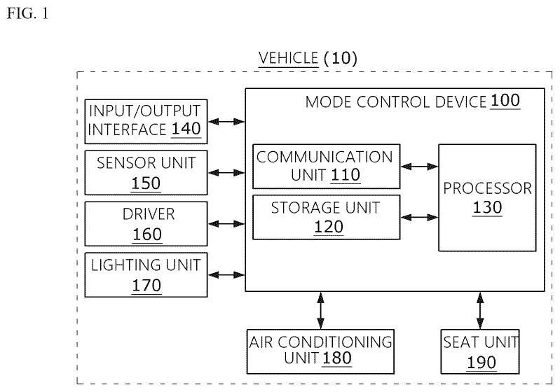

FIG. 1 is a configuration diagram illustrating a mode control device 100 of a vehicle 10.

The vehicle 10 may include the mode control device 100, a communication unit (also referred to as a communication interface) 110, a storage unit (also referred to as storage or data storage) 120, a processor 130, an input/output interface (also referred to as an input and output interface or a user interface) 140, a sensor unit (also referred to as one or more sensors) 150, a driving unit (e.g., a power train) 160, a lighting unit (also referred to as one or more lights) 170, an air conditioning unit (also referred to as an air conditioner) 180, and a seat unit (also referred to as one or more seats) 190. Each of the components in FIG. 1 may be implemented inside a vehicle.

The mode control device 100 is an electronic device or program which performs a function of controlling a plurality of mood curator modes for the convenience of occupants of the vehicle 10. The mode control device 100 may be integrally formed with the internal components of the vehicle, and may also be implemented as a separate device and connected to the internal components of the vehicle by a separate connection part. The mode control device 100 is shown as including the communication unit 110, the storage unit 120, and the processor 130, but may also be configured by including other components of the vehicle 10.

The communication unit 110 may enable the mode control device 100 to communicate with at least some configurations included in the vehicle 10, a user terminal, another vehicle, or an external server. The communication unit 110 may perform short range communication, global positioning system (GPS) signal reception, vehicle to everything (V2X) communication, optical communication, broadcast transmission/reception, and intelligent transport systems (ITS) communication functions.

The communication unit 110 may support short-range communication by using at least one of Bluetooth, radio frequency identification (RFID), Infrared Data Association (IrDA), Ultra Wideband (UWB), ZigBee, near field communication (NFC), wireless-fidelity (Wi-Fi), Wi-Fi direct, and wireless universal serial bus (wireless USB) technologies.

The storage unit 120 may store data generated or collected in at least some of the components related to control of the mood curator mode of the vehicle 10. The storage unit 120 may be provided inside the processor 130 or the mode control device 100, or may be a separate memory. The storage unit 120 may be composed of a combination of a non-volatile memory such as a hard disk drive, a flash memory, an electrically erasable programmable read-only memory (EEPROM), a static random access memory (SRAM), a ferro-electric RAM (FRAM), a phase-change RAM (PRAM), a magnetic RAM (MRAM), and the like, and/or a volatile memory such as a dynamic random access memory (DRAM), a synchronous dynamic random access memory (SDRAM), a double rate-SDRAM (DDR-SDRAM), and the like.

The processor 130 may be electrically connected to the communication unit 110, the storage unit 120, the input/output interface 140, the sensor unit 150, the driving unit 160, the lighting unit 170, the air conditioning unit 180, the seat unit 190, and various internal components of the vehicle 10, may electrically control each component, and may be an electrical circuit which executes software commands, thereby performing various types of data processing and calculations to be described below.

The processor 130 may process signals transmitted between the components of the vehicle 10, and may perform overall control so that the each of the components may normally perform its function. The processor 130 may be implemented in the form of hardware or software, or a combination of hardware and software.

The input/output interface 140 may include an input part for receiving a control command from a user and an output part for outputting the operation state and results of the mode control device 100. Here, the input part may include a physical key (for example, a physical button) and a soft key implemented on a touch display.

The output part may include a display, and further include a voice output part such as a speaker and a haptic module for generating vibrations. In this case, when a touch sensor such as a touch film, a touch sheet, or a touch pad is provided on the display, the display operates as a touch screen, and the input part and the output part may be implemented in an integrated form.

The input/output interface 140 may be implemented as a physical button, a head-up display (HUD), a cluster, an audio video navigation (AVN) device, a human machine interface (HMI), a user setting menu (USM), or the like.

For example, the vehicle 10 may receive an input related to mood curator mode control or may output a screen through the audio video navigation (AVN) device in a first row seats of the vehicle, a display of a console located in a second or third row of the vehicle, or a display of an application implemented in a user terminal.

The sensor unit 150 may include at least one of a radio detection and ranging (RADAR), a light imaging detection and ranging (LIDAR), an ultrasonic sensor, a fingerprint recognition sensor, a retina recognition sensor, an iris recognition sensor, a camera (for example, an internal camera, a thermal imaging camera, or the like), an infrared sensor, a heart rate sensor, an optical sensor, a pressure sensor, a seating sensor, and a motion sensor. The sensor unit 150 may collect biometric information such as an occupant's facial expression, heart rate, blood flow, body temperature, or the like.

The driving unit 160 may be configured to control motor driving or engine driving of the vehicle 10, and may perform a function of controlling the driving of components in the vehicle for user convenience. For example, the driving unit 160 may control the driving of a steering wheel, a vehicle seat, an interior light, an electric curtain, an air conditioning system, a scent diffusion device (also referred to as a diffuser or a scent diffuser), and the like, and may control the driving of each motor for this purpose.

The lighting unit 170 may include at least one light source capable of irradiating light into the interior of the vehicle. For example, the lighting unit 170 may include a sun visor lamp, a cluster lamp, a display lamp, a button lamp, a mood lamp, and the like. In this case, it is preferable that individual lighting elements constituting the lighting unit 170 may change at least one of a brightness and a color. The brightness or color may participate in a change in an interior lighting environment through on/off control when fixed.

The air conditioning unit 180 may include an air conditioning system (heating, ventilation, and air conditioning, HVAC) module. The air conditioning unit 180 may operate the air conditioning system of the vehicle 10 according to a control request of the mode control device 100.

The seat unit 190 may operate a power seat function (for example, an electric seat), a massage function, a swivel function, a recliner function, a heating wire and ventilation function, and the like of the seats included in the vehicle 10. The seat unit 190 may control at least some seats of the vehicle 10 and the functions of the corresponding seat according to the control request of the mode control device 100.

Hereinafter, the contents of controlling the mood curator mode of the vehicle will be described in detail through FIGS. 2 to 8. FIGS. 2 to 7 will be described with reference to FIG. 8. FIG. 8 is an exemplary diagram illustrating the internal components of the vehicle to be controlled in the control mode.

FIG. 2 is a flowchart illustrating a process of operating the control mode.

The mode control device 100 may confirm (e.g., determine) seating information (S210).

The mode control device 100 may detect which seat of the vehicle 10 the user sits on using an internal camera or seating sensor. For example, in FIG. 8, the mode control device 100 may confirm (e.g., determine) that there are two occupants in first row seats S1_A and S1_B and one occupant is in a passenger's seat S2_B among second row seats.

Next, the mode control device 100 may confirm (e.g., determine) an occupant's state (S230).

The mode control device 100 may confirm (e.g., determine) a user's state (also referred to as a user state), that is, an occupant's state through the sensor unit 150. For example, the mode control device 100 may confirm (e.g., determine) the states of three users in FIG. 8 through the sensor unit 150. The mode control device 100 may be communicatively connected to a user terminal or a wearable device of each occupant to collect biometric information of the corresponding occupant. The user's state may include, for example, biometric information such as the occupant's gender, age, facial expression, blood flow, heart rate, and body temperature.

The mode control device 100 may confirm (e.g., determine) a current condition state of the user based on biometric information, facial expression information, and the like of the user. To this end, the mode control device 100 may determine the facial expression of the user collected by the internal camera, a pulse rate of the user collected through a biometric sensor such as an electrocardiogram sensor, and the like using a pre-learned artificial intelligence (AI) tool (e.g., AI model) or database (DB) table. The mode control device 100 may recognize the determined result as a condition state. These condition states may be stored in advance in various mapping tables which are matched according to the biometric information, the facial expression information, and the like of the user.

For example, in FIG. 8, the mode control device 100 may recognize that the user sitting on a driver's seat S1_A in the first row seats is an adult male, and the current condition state is a ‘normal state’. The mode control device 100 may recognize that the user sitting on a passenger seat S1_B in the first row seats is an adult female, and the current condition state is a ‘good state’. The mode control device 100 may recognize that the user sitting on a passenger seat S2_B in the second row seats is a female child, and the current condition state is a ‘slightly bad state’.

Next, the mode control device 100 may determine control modes for mood curating (S250).

The control modes for the mood curating of the vehicle 10 may be classified into six control modes.

A first mode is, for example, a delight mode which is a mode that brightens and makes the atmosphere pleasant and induces the occupants to have a pleasant feeling.

A second mode is, for example, a calming mode which is a mode that provides a warm and comfortable atmosphere when the occupants want to drive comfortably or receive comfort.

A third mode is, for example, a cozy mode which is a mode that provides a posture and an atmosphere of a rest mode for the emotions and body care of the occupants.

A fourth mode is, for example, a siesta mode and may provide a front/rear seat rest area and a sleep content for healing during stops.

A fifth mode is, for example, a social mode and may provide a comfortable environment which allows two or more people to face each other and talk according to a seating situation.

A sixth mode is, for example, a theater mode and may provide a space for various activities based on personal taste and lifestyle.

Each control mode for the mood curating as above may be operated within a certain operating time. The mode control device 100 may continuously collect a biometric signal of the user, and suggest a time extension of a specific mode based on the collected content. The mode control device 100 may provide the user with a selection display capable of extending an operation maintenance time in the corresponding mode when the biometric signal of the user fluctuates below a certain value even when the specific mode has been operated for a certain time.

The first to third modes may be classified as a first group mode, and the fourth to sixth modes may be classified as a second group mode. The first group mode may be distinguished as a group which performs curating mainly for emotional care, and the second group mode may be distinguished as a group which performs curating mainly for space care.

A power condition of the first group mode and a power condition of the second group mode may be different. For example, the power condition of the vehicle in which the first group mode is operable may operate in a power mode of a power-on mode, a drive ready mode, or a utility mode. The power condition of the vehicle in which the second group mode is operable may operate only in the utility mode because object control in the second group mode has relatively higher power consumption than in the first group mode.

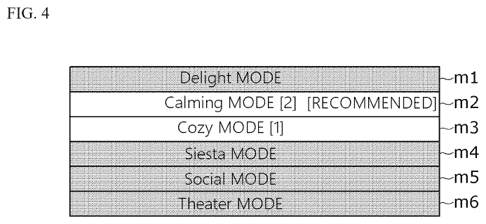

Meanwhile, a specific operation of operation S250 will be described with through contents in FIGS. 3 to 6. FIG. 3 is a flowchart illustrating a specific operation of operation S250 in FIG. 2, and FIGS. 4 to 6 are exemplary diagrams of a screen which recommends control modes.

In FIG. 3, the mode control device 100 may confirm (e.g., determine) the control mode available for each occupant (S305).

The mode control device 100 may determine a specific control mode for the mood curating of the vehicle 10 based on at least one of the seating information of the vehicle and the user's state.

For example, the mode control device 100 may confirm (e.g., determine) a control mode which is supportable for each of the three occupants in FIG. 8. The mode control device 100 may confirm (e.g., determine) the occupant's state and display the control mode suitable for the occupant's state. For example, the mode control device 100 may confirm (e.g., determine) that the calming mode is supportable for two occupants and the cozy mode is supportable for one occupant. The control mode suitable for each occupant's state may be recommended based on lookup tables set to be mapped in advance according to the occupant's state, or may be recommended by an AI-learned method based on conventional data.

Next, the mode control device 100 may confirm (e.g., determine) whether a control mode with the largest number of users is present (S310). For example, the mode control device 100 may confirm (e.g., determine) whether there is a mode that satisfies more than half of the total number of occupants.

When the control mode with the largest number of users is present, the mode control device 100 may display the corresponding control mode (S315). For example, when there are two occupants corresponding to the calming mode and one occupant corresponding to the cozy mode, as shown in FIG. 4, the mode control device 100 may display that there are two occupants and one occupant corresponding to calming mode m2 and cozy mode m3, respectively. In this case, the modes m2 and m3 having occupants suitable for the corresponding mode may be displayed distinctly from the modes m1, m4, m5, and m6 without suitable occupants. For example, regions of the modes m1, m4, m5, and m6 without suitable occupants may be shaded or their selection may be disabled.

Further, the control mode with the largest number of users (e.g., at least one recommended control mode) may be displayed distinctly from other control modes. In other words, the at least one recommended control mode may be displayed via the user interface by visually distinguishing the at least one recommended control mode among a plurality of available control modes to choose from. For example, the calming mode m2, which is the control mode with the largest number of users, may include the text “Recommended” in a display region. FIG. 4 illustrates that the modes m2 and m3 corresponding to even one occupant are displayed distinctly from the modes m1, m4, m5, and m6 that do not correspond to any other occupant, but only the mode m2 with largest number of users may be displayed distinctly from the other modes m1, m3, m4, m5, and m6.

When the control mode with the largest number of users is not present in operation S310, the mode control device 100 may confirm (e.g., determine) whether a preset priority is present (S320). For example, in FIG. 8, when it is determined that three occupants are suitable for different modes, the mode control device 100 may determine whether there is a preset priority factor in the memory among the three occupants. This priority factor may be preset based on age, gender, and the like, but is not limited thereto. In FIG. 8, since the user sitting on the second row seat S2_B is a female child, a mode suitable for the corresponding female child may be selected as a high priority according to a preset policy.

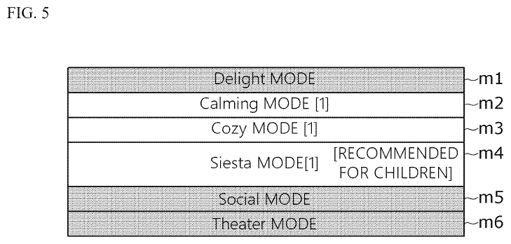

As described above, when a priority is present, the mode control device 100 may display the control mode according to the priority (S325). For example, as shown in FIG. 5, the calming mode m2, the cozy mode m3, and the siesta mode m4 suitable for each of the three occupants may be activated to be selectable and displayed distinctly from other modes m1, m5, and m6, and the phrase ‘Recommended for children’ may be further displayed in the siesta mode m4 suitable for a current state of the female child according to the priority. Accordingly, the mode m4 corresponding to the priority may be displayed distinctly from other modes m1, m2, m3, m5, and m6. Meanwhile, although FIG. 5 illustrates that the modes m2, m3, and m4 corresponding to even one occupant are displayed distinctly from the modes m1, m5, and m6 not corresponding to any occupant, only the mode m4 according to the priority factor may be displayed distinctly from other modes m1, m2, m3, m5, and m6.

When the priority factor is not present in operation S320, the mode control device 100 may display a possible control mode (S330).

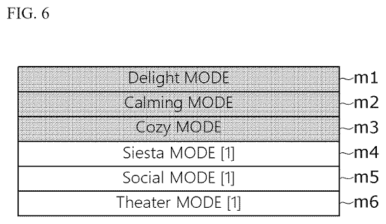

For example, when there are one occupant corresponding to the siesta mode, one occupant corresponding to the social mode, and one occupant corresponding to the theater mode among the three occupants, as shown in FIG. 6, the mode control device 100 may display that there are occupants respectively corresponding to the siesta mode m4, the social mode m5, and the theater mode m6. In this case, the modes m4, m5, and m6 having occupants suitable for the corresponding modes may be displayed distinctly from the modes m1, m2, and m3 having no suitable occupants for the corresponding modes. For example, regions of the modes m1, m2, and m3 without suitable occupants may be shaded or their selection may be disabled.

The above mode displays in FIGS. 4 to 6 may be displayed on a display 143 in front of the first row seats in FIG. 8, a display included in a first row seats console C1, a display 145 included in a second row seats console C2, and the like, but are not limited thereto, and may be displayed on various displays inside the vehicle 10.

Next, the mode control device 100 may determine a control mode by user selection or automatically (S335). For example, as shown in FIGS. 4 to 6, when the mode is recommended and displayed on the display of the vehicle 10, the user may select a desired mode through the input/output interface 140, and the mode control device 100 may determine the mode to be controlled in the vehicle 10 in response to the selection.

Meanwhile, the mode control device 100 may automatically determine the control mode without user selection. The mode control device 100 may automatically determine the most suitable mode, for example, as shown in FIG. 3 and/or using artificial intelligence. The mode control device 100 may learn accumulated mode selection results by considering the seating information and the user's state using the AI tool (e.g., AI model). When there are no plurality of modes or there is no priority, the mode control device 100 may determine an appropriate mode with reference to previously learned mode selection results.

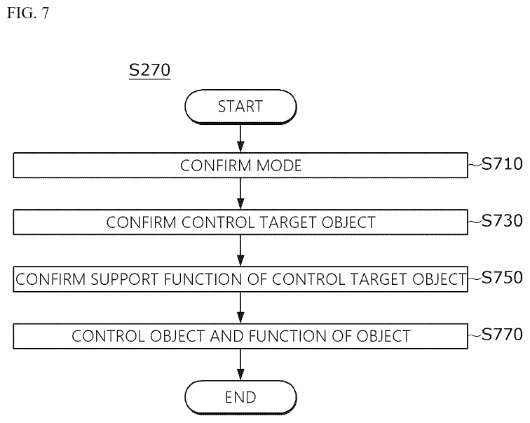

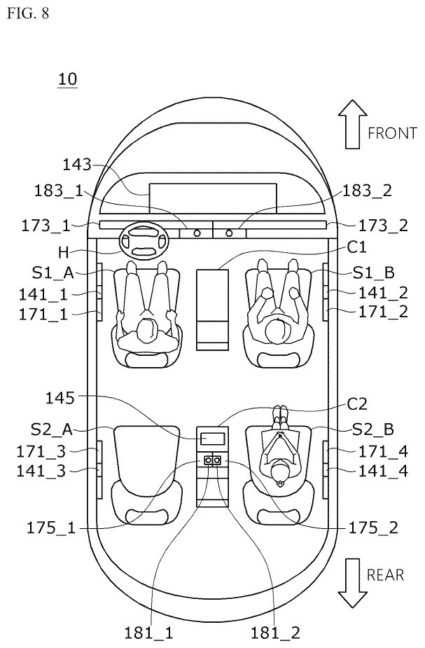

Referring to FIG. 2 again, the mode control device 100 may control an object inside the vehicle according to the confirmed mode (S270). A specific operation of operation S270 will be described through the contents in FIG. 7. FIG. 7 is a flowchart illustrating a specific operation of operation S270 in FIG. 2.

In FIG. 7, the mode control device 100 may confirm (e.g., determine) a mode (S710). Specifically, the mode control device 100 may confirm (e.g., determine) the control mode determined or selected through the above-described operation in FIG. 3.

Next, the mode control device 100 may confirm (e.g., determine) a control target object according to the corresponding mode (S730).

Specifically, the mode control device 100 may confirm (e.g., determine) an object to be controlled based on the seating information. For example, in the vehicle 10 in FIG. 8, the mode control device 100 may recognize a state in which a total of three occupants are seated on the seats S1_A and S1_B in the first row seats and the passenger seat S2_B of the seats in the second row seats. The mode control device 100 may determine only the seats S1_A, S1_B, and S2_B for which seating is recognized as a target object to be individually controlled in a specific mode. For the seat S2_A without an occupant, control related to the seat S2_A may be omitted in the specific mode.

Next, the mode control device 100 may confirm (e.g., determine) a support function of the control target object (S750). Specifically, the mode control device 100 may confirm (e.g., determine) whether the specific object to be individually controlled in the specific mode has a function that operates in the corresponding mode. The mode control device 100 may control only a function provided in the control target object among the functions to be individually controlled in the specific mode.

For example, in the third mode (for example, the cozy mode), a massage function of the seats may be set to operate. In FIG. 8, the vehicle 10 may be an optional vehicle having the massage function in the first row seats S1_A and S1_B but not having the massage function in the second row seats S2_A and S2_B. In this case, even in the seat S2_B on which the occupant is seated, control of the massage function of the corresponding seat S2_B may be omitted.

Next, the mode control device 100 may control functions which match the specific mode based on the object confirmed as the control target and functions supported by the object (S770).

As described above, the mood curating modes may be, for example, the first to sixth modes. Hereinafter, specific operation requirements in each mode will be described. The contents of the following operation requirements are only examples, and the operation requirements in each mode are not limited thereto. For example, the operating condition set to level 1 of a heating wire seat may be changed to level 2.

[First mode] Delight mode

| | Operation requirements when |
|---|---|
| Control target object | entering mode |
| Mood lamp | Color: Yellow |
| Electric curtain-rear door curtain | Open (Down) |
| Electric curtain - rear curtain | Open (Down) |
| Electric curtain - quarter glass curtain | Open (Down) |
| Seat heating wire and ventilation | Ventilation level 2 |

The control mode of the vehicle for the mood curating may include at least the first mode, and the first mode may control at least one of the color of the interior light (for example, a mood lamp), the operation of the electric curtain, and the heating wire and ventilation intensity of the vehicle seat. The first mode may operate with a first color (for example, Yellow).

In the specific mode, the mode control device 100 may distinguish an object to be individually controlled in the vehicle 10 based on the seating information and an object to be commonly controlled in the vehicle 10 regardless of the seating information.

For example, in FIG. 8, objects commonly used or located regardless of a specific seat, such as a front display (for example, an AVN display 143) and the interior light (for example, a mood lamp) included in the console C1, may be controlled without considering the seating information.

[Second mode] Calming mode

| | Operation requirements when |
|---|---|
| Control target object | entering mode |
| Mood lamp | Color: Purple |
| Electric curtain-rear door curtain | Close (Up) |
| Electric curtain - rear curtain | Close (Up) |
| Electric curtain - quarter glass curtain | Close (Up) |
| Seat heating wire and ventilation | Heating wire level 1 |
| Massage seat | Whole body intensity level 2 |

The control mode may further include at least the second mode, and the second mode may be a mode of controlling at least one of the color of the interior light (for example, a mood lamp), the operation of the electric curtain, the heating wire and ventilation intensity of the vehicle seat, and the massage function of the vehicle seat. The color of the interior light of the second mode may be a second color (for example, purple) different from the color of the interior light of the first mode.

[Third mode] Cozy mode

| | Operation requirements when |
|---|---|
| Control target object | entering mode |
| Mood lamp | Color: Green |
| Electric curtain-rear door curtain | Close (Up) |
| Electric curtain - rear curtain | Close (Up) |
| Electric curtain - quarter glass curtain | Close (Up) |
| Seat heating wire and ventilation | Heating wire stage 1 (=Heat Low) |
| Massage seat | Whole body intensity level 2 |
| Power seat | Relaxed seat position (possible in |
| | only second row) |

The control mode may further include at least the third mode, and the third mode may be a mode for controlling at least one of the color of the interior light (for example, a mood lamp), the operation of the electric curtain, the heating wire and ventilation intensity of the vehicle seat, the massage function of the vehicle seat, and an adjustment of a power (electric) seat. The color of the interior light of the third mode may be a third color (for example, green) different from the colors of the interior lights of the first mode and the second mode.

[Fourth mode] Siesta mode

| Control target | 4-1 Sleeping | 4-2 During | 4-3 Sleeping |
|---|---|---|---|
| object | preparation | sleeping | completed |
| Mood lamp | Off | Off | Red |
| Rear door | Close (Up) | Close (Up) | Open (Down) |
| curtain | | | |
| Rear curtain | Close (Up) | Close (Up) | Open (Down) |
| Quarter glass | Close (Up) | Close (Up) | Open (Down) |
| curtain | | | |
| Seat heating | Heating wire | Heating wire | Ventilation level |
| wire and | level 1 (=Heat | level 1 (=Heat | 3 (=Vent High) |
| ventilation | Low) | Low) | |
| Massage seat | Whole body | Off | Whole body |
| | intensity level | | intensity level |
| | 2 | | 2 |
| Power seat | Relaxed seat | Relaxed seat | Relaxed seat |
| | position | position | position |
| | (first and | (first and | (first and |
| | second rows | second rows | second rows |
| | may be | may be | may be |
| | simultaneously | simultaneously | simultaneously |
| | selected) | selected) | selected) |
| Steering | Relaxation | Relaxation | Relaxation |
| wheel | mode position | mode position | mode position |

The control mode may further include at least the fourth mode, and the fourth mode may be a mode for controlling at least one of the color of the interior light, the on/off of the electric curtain, the heating wire and ventilation intensity of the vehicle seat, the massage function of the vehicle seat, the adjustment of the power (electric) seat, and the position of the steering wheel. The color (for example, red) of the interior light of the fourth mode may be different from the colors of the interior lights of the first mode to the third mode. The fourth mode is a sleep mode, and may include a 4-1 mode (a sleeping preparation state), a 4-2 mode (a sleeping state), and a 4-3 mode (a sleeping completed state) according to each sleep state. The functions of the object may be differently controlled according to the 4-1 mode, the 4-2 mode, and the 4-3 mode.

[Fifth mode] Social mode

| | Operation requirements when |
|---|---|
| Control target object | entering mode |
| Mood lamp | Dimmed |
| Electric curtain-rear door curtain | Close (Up) |
| Electric curtain - rear curtain | Close (Up) |
| Electric curtains-quarter glass curtain | Close (Up) |
| Power seat | First row swivel seat position |
| Steering wheel | First position |

The control mode may further include at least the fifth mode, and the fifth mode may be a mode of controlling at least one of the color of the interior light, the on/off of the electric curtain, the heating wire and ventilation intensity of the vehicle seat, the massage function of the vehicle seat, adjustment of the power (electric) seat, and the position of the steering wheel. The interior light (for example, a mood lamp) of the fifth mode may be dimmed. The swivel seat position means a position rotated in a specific direction based on a vertical axis of the vehicle seat. Accordingly, space care in which the occupants in the first row seats and the second row seats may face each other and talk may be provided.

[Sixth mode] Theater mode

| | Operation requirements when |
|---|---|
| Control target object | entering mode |
| Mood lamp | Dimmed |
| Electric curtain-rear door curtain | Close (Up) |
| Electric curtain - rear curtain | Close (Up) |
| Electric curtain - quarter glass curtain | Close (Up) |
| Power seat | First row relaxed seat position |
| Steering wheel | First position or second position |

The control mode may further include at least the sixth mode, and the sixth mode may be a mode of controlling at least one of the color of the interior light, the on/off of the electric curtain, the heating wire and ventilation intensity of the vehicle seat, the massage function of the vehicle seat, the adjustment of the power (electric) seat, and the position of the steering wheel. The interior light (for example, a mood lamp) of the sixth mode may be dimmed. In the sixth mode, the relaxed seat position may mean a position where the seat has moved from the existing first position to a second position. The movement according to the first position and the second position may include at least one of a horizontal direction, a vertical direction, or a rotation direction for securing space. Further, the first position or the second position of the steering wheel may also include at least one of the horizontal direction, the vertical direction, and the rotation direction for securing space.

Meanwhile, the control target object in the above-described first to sixth modes may further include an air conditioning system and a scent diffusion device. The mode control device 100 may control the operation requirements of the air conditioning system (for example, an air conditioner, heater, and the like) to be the same as the heating wire intensity and ventilation intensity logic of the seat in the above first to sixth modes.

The mode control device 100 may compare an internal temperature of the vehicle 10 with the body temperature of the user and control the temperature differently for each mode and seat.

Specifically, the mode control device 100 may detect a current temperature of the vehicle 10. Further, temperatures of the occupants sitting in the vehicle 10 may be individually detected through the sensor unit 150. When a difference between the internal temperature of the vehicle 10 and the body temperature of the occupant is greater than or equal to a certain value, the mode control device 100 may control the function of the control target object related to the occupant differently in the specific mode.

For example, referring to FIG. 8, temperatures of the occupant of the first row passenger seat S1_B and the occupant of the second row passenger seat S2_B may be lower than the certain value compared to the current internal temperature of the vehicle 10, and the temperature of the occupant of the first row driver seat S1_A may be higher than or equal to the certain value. When currently operating in the second mode (for example, the calming mode), the mode control device 100 may change the seat heating wire of the first row driver's seat S1_A to OFF, increase the air conditioning intensity of an air conditioning system 183_1 at the first row driver's seat side, or decrease the heater intensity.

Similarly, the mode control device 100 may control at least some of air conditioning systems 183_1, 183_2, 181_1, and 181_2 of each seat of the vehicle 10 differently based on the seating information.

The mode control device 100 may control the interior lightings of the vehicle 10 differently based on the seating information in the specific mode.

Specifically, the mode control device 100 may control interior lightings 171_1, 171_2, 171_3, and 171_4 of the door trim which are controlled dependently on the input selected in each seat or a region adjacent to each seat in FIG. 8 commonly or differently according to the specific mode. For example, the occupant may press buttons 141_1, 141_2, 141_3, and 141_4 of the door trim to select various functions (for example, window adjustment and swivel seat driving), and in response to this, the mode control device 100 may control the adjacent interior lightings 171_1, 171_2, 171_3, and 171_4 to emit light when the user selection is input.

Further, when the occupants individually control the air conditioning systems 183_1, 183_2, 181_1, and 181_2 corresponding to the seats on which the occupants are sitting, the mode control device 100 may control the interior lightings 173_1, 173_2, 175_1, and 175_2 adjacent to the air conditioning systems to emit light when the user selection is input. In this case, the mode control device 100 may control the adjacent interior lighting to emit light differently according to a specific control input of the air conditioning system. For example, when the user presses a button to further lower the air conditioning temperature for the specific air conditioning system 183_1, the mode control device 100 may emit light with a specific color (for example, blue) whenever the corresponding button is pressed.

In the specific mode, the mode control device 100 may detect the weights of users sitting on the seats of the vehicle 10, and may control the mode or intensity of the massage function of each seat differently based on the weight. In addition, the mode control device 100, during autonomous driving control of the vehicle, may control, based on the control mode, at least one vehicle object in the vehicle.

Meanwhile, in the various example embodiments as described herein, although contents for controlling the control target objects or the functions of the control target object differently according to the specific mode have been disclosed, not only this individual control but also common control according to the specific mode may be included. For example, the interior light, the electric curtain, the audio system, the display, and the like which are not dependent on the seat and are commonly located may be commonly controlled to be suitable for the specific mode.

The term “unit” used in one or more example embodiment means a software or hardware component such as a field-programmable gate array (FPGA) or an application-specific integrated circuit (ASIC), and the “unit” performs certain roles. However, the “unit” is not limited to software or hardware. The “unit” may be configured to be in an addressable storage medium or may be configured to play one or more processors. Accordingly, for example, the “unit” includes components such as software components, object-oriented software components, class components, and task components, processes, functions, attributes, procedures, subroutines, segments of program code, drivers, firmware, microcode, circuits, data, databases, data structures, tables, arrays, and variables. The functions provided in the components and “units” may be combined into a smaller number of components and “units” or may be further separated into additional components and “units”. In addition, the components and the “units” may be implemented to play one or more CPUs in a device or a secure multimedia card.

A mode control device may include: a memory in which information on at least one control mode related to a vehicle is stored; and a processor connected to the memory, wherein the processor confirms seating information of the vehicle and a user's state, determines a specific control mode based on at least one of the confirmed seating information and user's state, and controls at least one object included inside the vehicle according to the determined specific control mode.

The object may include at least one of an interior light, a vehicle seat, an electric curtain, a steering wheel, an air conditioning system, and a scent diffusion device of the vehicle, and the control mode may include two or more control modes that adjust at least some of the interior light, the seat, the electric curtain, the steering wheel, the air conditioning system, and the scent diffusion device of the vehicle differently.

The processor may individually control at least some objects inside the vehicle according to the specific control mode.

The processor may individually control objects related to a seat on which a user is sitting.

The processor may confirm a support function of the object related to the seat on which the user is sitting, and control a function of the object related to the seat on which the user is sitting within the confirmed support function.

The processor may determine at least one recommended control mode based on the seating information and the user's state, output the at least one determined recommended control mode through an input/output interface, and determine any one control mode selected through the input/output interface as the specific control mode.

The processor may display the recommended control mode through the input/output interface to be distinguished from other control modes excluding the recommended control mode.

If there is a control mode corresponding to a majority of control modes corresponding to a plurality of users, the processor may determine the control mode corresponding to the majority as the recommended control mode.

The processor may determine any one control mode as the recommended control mode by considering a priority factor according to the user's state when the number of control modes corresponding to the plurality of users is the same.

The processor may determine the recommendation control mode based on an accumulatively learned content of the seating information and the user's state using an artificial intelligence (AI) tool.

The two or more control modes may be classified as two different group modes having different power conditions.

A vehicle may include: an input/output interface; and a mode control device that confirms seating information of the vehicle and a user's state, determines a specific control mode based on at least one of the confirmed seating information and user's state, and controls at least one object included inside the vehicle according to the determined specific control mode.

A control method may be performed by a mode control device to control an object inside a vehicle, and the method may include: confirming seating information of the vehicle and a user's state; determining a specific control mode based on at least one of the confirmed seating information and the user's state; and controlling at least one object included inside the vehicle according to the determined specific control mode.

The object may include at least one of an interior light, a vehicle seat, an electric curtain, a steering wheel, an air conditioning system, and a scent diffusion device of the vehicle, and the control mode may include two or more control modes that adjust at least some of the interior light, the seat, the electric curtain, the steering wheel, the air conditioning system, and the scent diffusion device of the vehicle differently.

The controlling of the at least one object may include individually controlling at least some objects inside the vehicle according to the specific control mode.

The individually controlling of the at least some objects may include individually controlling objects related to a seat on which a user is sitting.

The individually controlling of the object related to the seat on which the user is sitting may include confirming a support function of the object related to the seat on which the user is sitting; and controlling the function of the object related to the seat on which the user is sitting within the confirmed support function.

The determining of the specific control mode may include determining at least one recommended control mode based on the seating information and the user's state; outputting the at least one determined recommended control mode through an input/output interface; and determining any one control mode selected through the input/output interface as the specific control mode.

The outputting of the at least one recommended control mode through the input/output interface may include displaying the recommended control mode to be distinguished from other control modes excluding the recommended control mode.

The determining of the at least one recommended control mode based on the seating information and the user's state may include, when there is a control mode corresponding to a majority of control modes corresponding to a plurality of users, determining the control mode corresponding to the majority as the recommended control mode.

Since various modes that take the seating information of a vehicle and a user's state into consideration are provided, a customized convenience function according to a user and a vehicle state can be provided.

Further, since the seating information and functions supported by a target object to be controlled are confirmed, unnecessary function operation can be minimized and more sophisticated convenience functions and modes of supporting the same can be provided.

The effects of the present disclosure are not limited to the above-mentioned effects, and other effects which not mentioned will be clearly understood by those skilled in the art from the following description.

Although some example embodiments of the present disclosure are described above, those skilled in the art should understand that the present disclosure may be variously modified and changed without departing from the spirit and scope of the present disclosure described in the following claims.

What is claimed is:

1. A mode control device comprising:
a sensor to detect seating information of a vehicle and a user state sitting on the vehicle;
memory storing information on at least one control mode related to the vehicle; and
a processor connected to the memory,
wherein the processor is configured to:
determine, via communication with the sensor, the seating information of the vehicle and the user state;
determine, based on at least one of the seating information or the user state, a control mode of a plurality of control modes for the vehicle; and
control, based on the control mode, at least one vehicle object in the vehicle.

2. The mode control device of claim 1, wherein the at least one vehicle object comprises at least one of: an interior light, a seat, an electric curtain, a steering wheel, an air conditioning system, or a scent diffuser, and
wherein each control mode, of the plurality of control modes, corresponds to a different setting for at least one of: the interior light, the seat, the electric curtain, the steering wheel, the air conditioning system, or the scent diffuser.

3. The mode control device of claim 1, wherein the processor is configured to control the at least one vehicle object by individually controlling at least two vehicle objects in the vehicle according to the control mode.

4. The mode control device of claim 3, wherein each of the at least two vehicle objects is related to at least one seat on which at least one user is sitting.

5. The mode control device of claim 4, wherein the processor is configured to control the at least two vehicle objects by:
determining a support function of each of the at least two vehicle objects; and
controlling the support function of each of the at least two vehicle objects.

6. The mode control device of claim 1, wherein the processor is configured to determine the control mode by:
determining, based on the seating information and the user state, at least one recommended control mode;
outputting, via a user interface, the at least one recommended control mode; and
determining the control mode by receiving, via the user interface, a selected control mode of the at least one recommended control mode.

7. The mode control device of claim 6, wherein the processor is configured to display, via the user interface, the at least one recommended control mode by visually distinguishing the at least one recommended control mode among the plurality of control modes.

8. The mode control device of claim 6, wherein the processor is configured to determine the at least one recommended control mode by:
determining, as the at least one recommended control mode, at least one control mode that is selected by a number of a plurality of users, wherein the number of the plurality of users satisfies a threshold.

9. The mode control device of claim 6, wherein the processor is configured to determine the at least one recommended control mode by:
determining the at least one recommended control mode further based on a priority factor associated with the user state.

10. The mode control device of claim 6, wherein the processor is configured to determine the at least one recommended control mode by:
determining the at least one recommended control mode further based on an accumulatively learned content by an artificial intelligence model using the seating information and the user state.

11. The mode control device of claim 1, wherein two or more control modes, of the plurality of control modes, are classified as two different group modes having different power conditions.

12. A vehicle comprising:
a sensor to detect seating information of the vehicle and a user state sitting on the vehicle;
a user interface configured to receive a user input associated with at least one control mode related to the vehicle;
memory storing information on the at least one control mode related to the vehicle; and
a processor connected to the memory,
wherein the processor is configured to:
determine, via communication with the sensor, the seating information of the vehicle and the user state;
based on at least one of the seating information or the user state, determine a control mode of a plurality of control modes for the vehicle; and
during autonomous driving control of the vehicle, control, based on the control mode, at least one vehicle object in the vehicle.

13. A method performed by an apparatus of a vehicle, the method comprising:
detecting, via a sensor of the vehicle, seating information of the vehicle and a user state sitting on the vehicle;
determining, via communication with the sensor, the seating information of the vehicle and the user state;
determining, based on at least one of the seating information or the user state, a control mode of a plurality of control modes for the vehicle; and
controlling, based on the control mode, at least one vehicle object in the vehicle.

14. The method of claim 13, wherein the at least one vehicle object comprises at least one of: an interior light, a seat, an electric curtain, a steering wheel, an air conditioning system, or a scent diffuser, and
wherein each control mode, of the plurality of control modes, corresponds to a different setting for at least one of: the interior light, the seat, the electric curtain, the steering wheel, the air conditioning system, or the scent diffuser.

15. The method of claim 13, wherein the controlling of the at least one vehicle object comprises individually controlling at least two vehicle objects in the vehicle according to the control mode.

16. The method of claim 15, wherein each of the at least two vehicle objects is related to at least one seat on which at least one user is sitting.

17. The method of claim 16, wherein the individually controlling of the at least two vehicle objects comprises:
determining a support function of each of the at least two vehicle objects; and
controlling the support function of each of the at least two vehicle objects.

18. The method of claim 13, wherein the determining of the control mode comprises:
determining, based on the seating information and the user state, at least one recommended control mode;
outputting, via a user interface, the at least one recommended control mode; and
determining the control mode by receiving, via the user interface, a selected control mode of the at least one recommended control mode.

19. The method of claim 18, wherein the outputting of the at least one recommended control mode comprises:
displaying, via the user interface, the at least one recommended control mode by visually distinguishing the at least one recommended control mode among the plurality of control modes.

20. The method of claim 18, wherein the determining of the at least one recommended control mode comprises:
determining, as the at least one recommended control mode, at least one control mode that is selected by a number of a plurality of users, wherein the number of the plurality of users satisfies a threshold.
